(19) United States
(12) Patent Application Publication
(10) Pub. No.: US 2017/0161032 A1
(43) Pub. Date: Jun. 8, 2017

(54) RUNNING APPLICATIONS USING PRE-GENERATED COMPONENTS

(71) Applicant: Alibaba Group Holding LImited, George Town (KY)

(72) Inventors: Shuting CHEN, Hangzhou (CN); Jibin XIE, Hangzhou (CN); Yang LU, Hangzhou (CN); Guimin GAN, Hangzhou (CN); Min CHANG, Hangzhou (CN)

(21) Appl. No.: 15/366,852

(22) Filed: Dec. 1, 2016

(30) Foreign Application Priority Data
Dec. 2, 2015 (CN) 201510873960.3

(51) Int. Cl. G06F 9/44

(52) U.S. Cl. CPC G06F 8/36; G06F 8/35; G06F 8/20

(57) ABSTRACT

Embodiments of the present application provide a method and device for initializing an application using common components. One such method includes storing pre-generated components in a component library, acquiring characteristic data from a server according to information related to the application and information related to the function item when a function item of the application is requested to start, determining necessary components in the component library according to the characteristic data, and starting the function item using the necessary components. The method can improve the implementation efficiency of the application and reduce the wasting of resources.

### CROSS-REFERENCE TO RELATED APPLICATION

This application claims priority to Chinese Patent Application No. 201510873960.3, filed on Dec. 2, 2015, which is incorporated herein by reference in its entirety.

### TECHNICAL FIELD

The present application relates to the field of software applications, and particularly to a method and device for developing and/or executing software applications using pre-generated components.

### BACKGROUND

Recently a great number of applications (apps) have been developed, and the same developer may provide a variety of different apps. Even when the apps are different, the apps may have similar functions, especially when several apps are provided by the same developer. However, when each app is developed separately, efficiency is greatly reduced and development resources are wasted. What is needed is a processing technique that can use common components to reduce development costs and improve efficiency.

### SUMMARY

One object of the present application is to provide a method for developing an application that improves the implementation efficiency of the application and reduces the amount of resources consumed. Another object of the present application is to provide an application processing device for using common application components.

According to one embodiment, a method for implementing a function item of an application using pre-generated components is disclosed. The method includes storing pre-generated components in a component library, acquiring characteristic data from a server based on information related to an application and information related to a function item of the application, responsive to a request to start the function item of the application, determining a necessary component in the component library for starting the function item based on the characteristic data, and starting the function item using the necessary component.

According to another embodiment, a device for executing an application using common components is disclosed. The device includes a memory for storing pre-generated components in a component library, and a processor for acquiring characteristic data from a server based on information related to the application and information related to the function item responsive to a request to execute a function item of the application, determining a necessary component for the function item in the component library based on the characteristic data, and initializing the function item using the necessary component.

Additional aspects and advantages of the present application will be given in part in the following description, and will be obvious from the following description in part, or will be understood by practice of the present application.

### BRIEF DESCRIPTION OF THE DRAWINGS

The above and/or additional aspects and advantages of the present application will become apparent and easily understood from the following descriptions of embodiments in conjunction of the drawings, in which:

FIG. 1 is a flow diagram of an exemplary application processing method using pre-generated components according to embodiments of the present application;

FIG. 2 is a diagram of an exemplary application development system according to embodiments of the present application;

FIG. 3 is a flow diagram of an exemplary processing application processing method using pre-generated components according to embodiments of the present application;

FIG. 4 is a diagram of an exemplary application processing device according to embodiments of the present application;

FIG. 5 is a diagram of an exemplary application processing device according to embodiments of the present application.

### DETAILED DESCRIPTION

Embodiments of the present application will be described in detail, and examples of the embodiments are illustrated in the drawings in which the same or similar reference numerals throughout the specification indicate identical or similar modules or modules having identical or similar functions. Embodiments described below with reference to the drawings are illustrative, and are only for the purpose of explaining the present application instead of being construed as limiting the present application. On the contrary, embodiments of the present application include all changes, modifications and equivalents that fall within the spirit and scope of the appended claims.

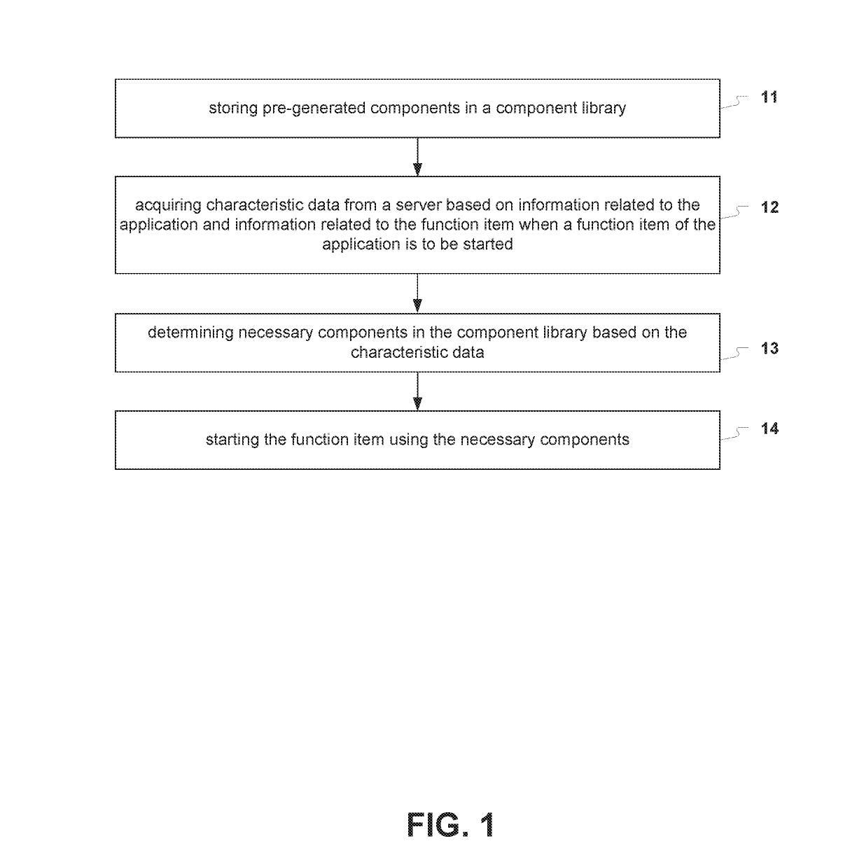

FIG. 1 is a flow diagram of an exemplary processing method for developing an application using common components according to embodiments of the present application.

At step 11, pre-generated components are stored in a component library.

An application system includes a client program (app) and a server program. The client program may include a service packet, a component library, a core library, a data layer, an adaptation layer, and an application environment.

The service packet is the app's private package which contains logic processing programs executed by the app based on the app's service characteristics. Different apps may have different service packets with different service characteristics. By using different service packets, the same components can be displayed in different styles and layouts.

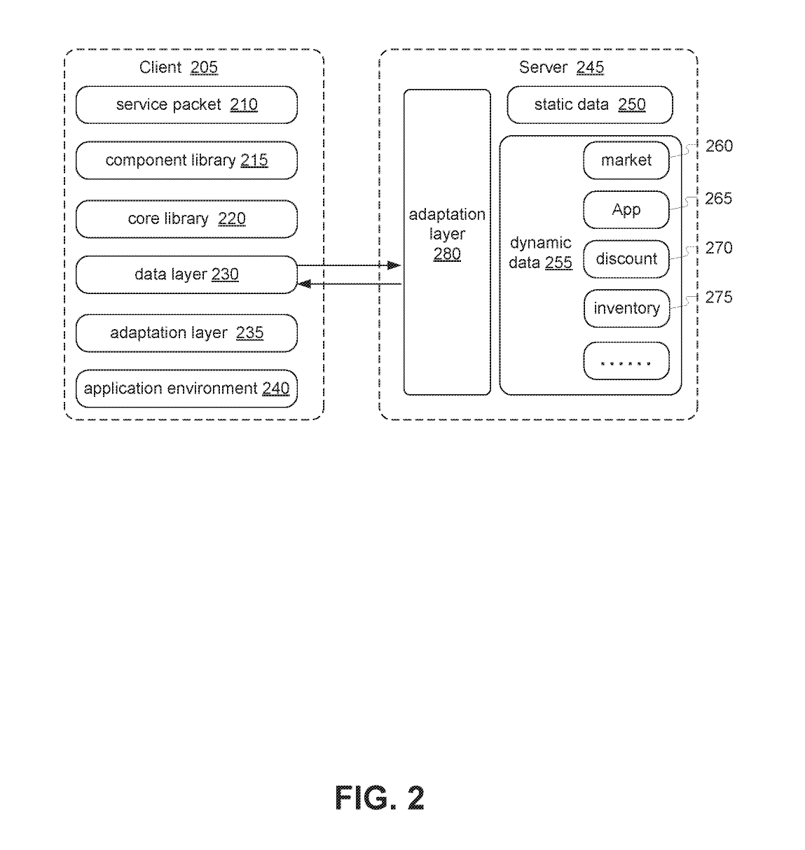

The component library, the core library, and the data layer are commonly used by different apps. The component library includes general-purpose components displayed in individual apps. The core library includes base libraries, for example, an event center, a thematic library, a template cache, etc. The data layer may contain interface data and is used for data communication. Although not shown in FIG. 2, the modules commonly available to different apps may also include other modules, such as a flow management module and a life cycle management module.

The adaptation layer ensures that codes, such as the component library, the core library, and the like, can successfully run in individual app environments. The main function of the adaptation layer is to build a bridge between a service layer (e.g., the service packet, the component library, the core library and the data layer, and the like) and an app layer (e.g., the application environment), such that the component library and the core library can successfully run in different app application environments, without destroying the original app's design and characteristic. The adaptation layer generally binds the protocol with particular implementations of different apps using dependence registration during service layer initialization. The service layer indirectly uses the app's particular implementation by invoking an interface defined by the adaptation layer.

The application environment includes one or a plurality of apps, the plurality of apps can be located at the same or different mobile terminals, with different apps having different network ports/addresses and user behavior detections, for example.

The server is used to provide data for the client. In order for different apps to acquire data from the server using a uniform interface, the server is provided with an adaptation layer. The adaptation layer of the server responds to app requests and returns data corresponding to the app. Data of the server may be classified into static data(e.g., data that does not change) and dynamic data (e.g., data that changes depending on conditions).

When the component is a User Interface (UI) component, the component can be stored in the component library of the client. For example, when a key value of the common component is set to A, then a corresponding component implementation class may be set for A. When the component implementation class of the common component is represented by B, then specific contents of the key value A and specific contents of the component implementation class B can be stored in the component library, and the association between the key value A and the component implementation class B is established. Specifically, the association between the key value A and the component implementation class B can be recorded in a component mapping configuration table in the component library.

Unlike separate development of individual apps, the common component A can be used by different apps, thus repetitive development and the wasting of resources is avoided.

At step 12, characteristic data is acquired from the server according to information related to the application and information related to the function item when a function item of the application is to be started.

The characteristic data may include static data and/or dynamic data, and different apps may have different characteristic data.

The characteristic data may be different for different function items. For example, when the page content is to be displayed, the characteristic data may include: interface data associated with the page content to be displayed and the layout template data of the page presentation. When the page contents to be displayed are commodity details, the interface data, for example, includes: information related to commodity details such as commodity image, commodity title, commodity price, commodity location and the like. The layout template data is used for describing the layout of the page presentation, for example, including which components should be used and the presentation sequence of the components.

According to some embodiments, acquiring characteristic data from the server according to information of the application and information of the function item includes sending a request message to the adaptation layer of the server, the request message containing information of the application and information of the function item, and receiving characteristic data sent by the server, the characteristic data being acquired by the server according to information of the application and information of the function item, where the adaptation layer of the server is able to receive request messages sent by different applications.

The server is provided with the adaptation layer so that different apps may send request messages to the unified adaptation layer of the server through the data layer of the client. Associations between application data, function items data, and characteristic data may be pre-configured at the client to acquire corresponding characteristic data based on applications data and function items data. Information related to the application may include the name and version number of the application, for example. For commodity detail pages, function item data may be an ID of the commodity to be displayed, for example.

At step 13, necessary components are determined in the component library according to the characteristic data.

For example, the characteristic data may include information about the necessary components used to identify and determine the necessary components.

At step 14, the function item is started using the necessary components.

After determining the necessary components, specific component implementation classes stored in the component library can be used to implement functions of the components. When a plurality of components need to be used, functions of the necessary components are combined to start or execute the function items of the application.

By storing the components in the component library, the same components used by different applications may be created once, and do not need to be developed separately for each application. Therefore, the implementation efficiency of the application may be improved and the wasting of resources may be reduced.

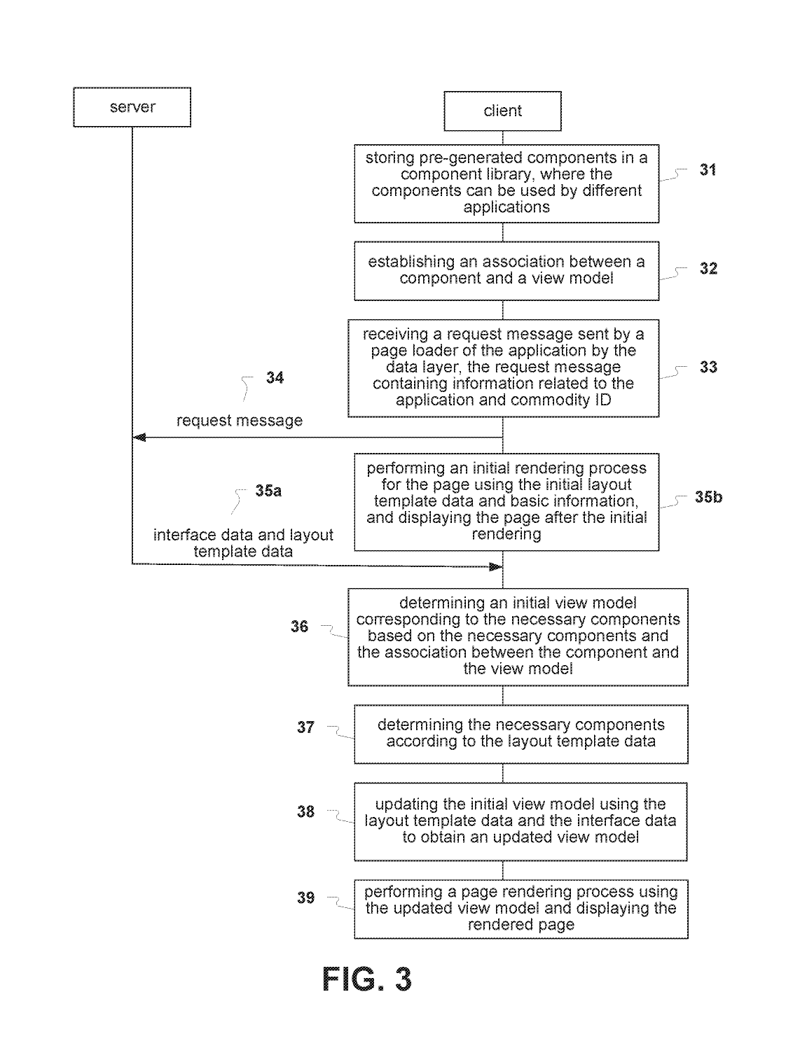

FIG. 3 is a flow diagram of an exemplary method for processing an application using pre-generated components according to an embodiment of the present application. The function items of the application to be started may include commodity detail pages within the displayed application, for example.

At step 31, pre-generated components are stored in a component library, where the components can be used by different applications.

For example, if the key value of the pre-generated component is A, and the implementation class of the component is B, the key value A and the component implementation class B can be stored in the component library and the association between the key value A and the component implementation class B can be established.

At step 32, an association between the component and a view model is established.

The view model is used for graphical rendering and contains the information required by the graphical rendering component of the UI.

Specifically, the association between the component and the view model can be established in a data layer, for example, a key value A may correspond to a view model C.

At step 33, the data layer receives a request message sent by the application's page loader, where the request message contains information related to the application and the commodity ID.

Information related to the application, for example, may include names and version numbers of applications.

The commodity ID identifies the commodity to be displayed in the detail page.

At step 34, a request message is sent to the adaptation layer of the server, and the request message contains information related to the application and commodity ID.

When the request message sent by the page loader is received by the data layer, the commodity detail page of the application to be started can be determined, and the request message is sent to the adaptation layer of the server to acquire the characteristic data.

At step 35a, interface data and layout template data is received from the server, where the interface data and layout template data is acquired by the server according to information related to the application and commodity ID.

The server can pre-store the commodity ID and the interface data in association with each other, such that the corresponding interface data can be acquired based on the commodity ID. The interface data may include information related to commodity details such as commodity title, price, image or the like.

In addition, the server may also pre-store information related to the application and the layout template data in association with each other, such that the corresponding layout template data can be acquired based on information of the application.

The server, after acquiring the interface data and the layout template data in the pre-stored data, may send the interface data and the layout template data to the data layer of the client.

At step 36, the necessary component is determined according to the layout template data by the client

For example, the layout template data may contain information related to the necessary components, such as which components need to be used, and the arrangement sequence of the components, such that the necessary components can be determined.

At step 37, an initial view model is determined for the necessary components based on the necessary components and the association between the component and the view model.

For example, if the key value of the component needed to be used is A, because the view model corresponding to A in the pre-established association is C, it can be determined that the initial view model is C.

At step 38, the initial view model is updated according to the layout template data and the interface data to obtain an updated view model.

The specific numerical value in the initial view model may be null, and after processing by the layout template data and interface data, a specific numerical value can be set, for example, using a commodity price, commodity title and/or commodity image or the like, to obtain the updated view model.

At step 39, a page rendering process is performed using the updated view model to display a rendered page.

The updated view model contains the information required for rendering the page, and specific content of the commodity detail pages can be obtained and displayed by rendering the updated view model.

According to some embodiments, when the network environment is relatively poor, such that the interface data and layout template data cannot be acquired, in order to facilitate the user's viewing of basic information, the rendering of the page can be based on or selected from a first rendering and a secondary rendering. The updated view model based on the interface data and layout template data and the rendering based on the updated view model is the secondary rendering. The first rendering can be performed according to the initial data.

The following steps are optional may be performed between step 34 and step 35a:

At step 35b, an initial rendering process is performed for the page using an initial layout template data and basic information, and the page is displayed using the initial rendering.

The initial layout template data and basic information can be pre-configured, so that the user can see the basic page content such as titles and prices of the displayed commodity, or the like.

Modular solutions used across apps can be realized through common components from different applications. With a single development process, the services can be easily applied to different apps installed on a mobile terminal. This greatly reduces development cost, and the services can be brought on-line quickly and in parallel.

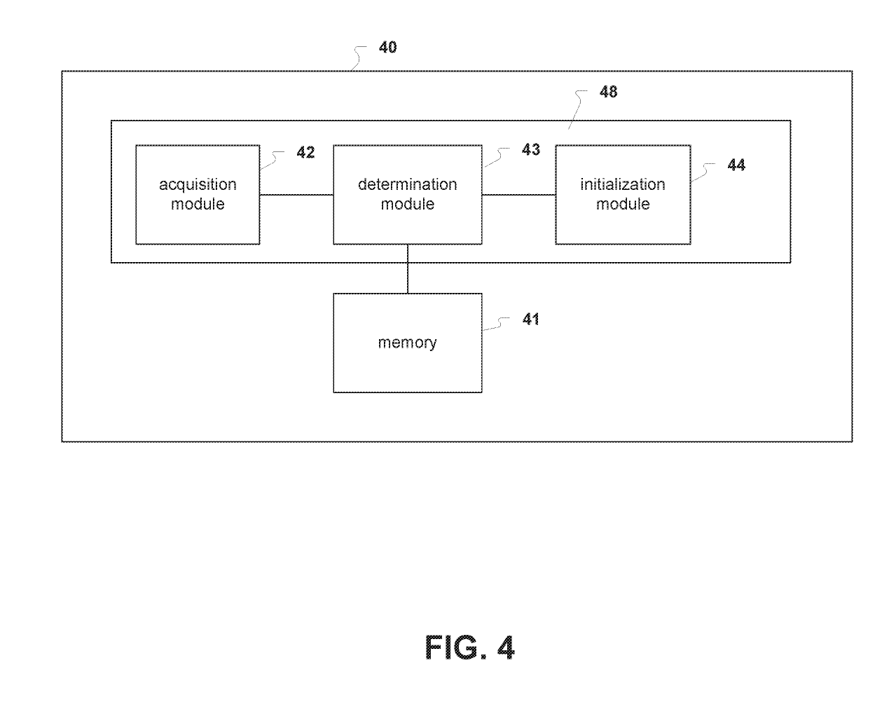

FIG. 4 is a diagram of an exemplary processing device according to embodiments of the present application. The device 40 includes a memory 41, an acquisition module 42, a determination module 43, and an initialization module 44. The modules may be implemented as separate components, or included in processor 48. Processor 48 is communicatively coupled to memory 41. Memory 41 may be used to store data processed by processor 48, and may include RAM, ROM, Flash memory, or a magnetic tape or disk drive, for example. According to some embodiments, memory 41 is used to store a component library, and processor 48 executes the functions of acquisition module 42, determination module 43, and initialization module 44.

Memory 41 may be used for storing pre-generated components in a component library, where the component may be used by different applications.

Referring to FIG. 2, the application system may include a client program (app) 205 and a server program 245, where the client program may include a service packet 210, a component library 215, a core library 220, a data layer 230, an adaptation layer 235, and an application environment 240.

The service packet 210 is the app's private package and may contains logic processing programs of the app that correspond to the app's service characteristics. Different apps may have different service packets with different service characteristics. By using different service packets, the same components can be displayed in different styles and layouts.

The component library 215, the core library 220, and the data layer 230 are commonly available to different apps. The component library 215 includes general-purpose components displayed in individual apps. The core library 220 includes base libraries, for example, an event center, a thematic library, a template cache, or the like. The data layer 230 contains definitions of interface data and is used for data communication. Although not shown in FIG. 2, the modules available to the different apps may also include other modules, such as a flow management module and a life cycle management module.

The adaptation layer 235 ensures that code from the component library 2115, the core library 220, and the like can successfully run in the individual app environments. The main function of the adaptation layer 235 is to build a bridge between a service layer (e.g., the service packet, the component library, the core library, the data layer, and the like) and an app layer (e.g., the application environment), such that the component library and the core library can successfully run in different app application environments, without destroying the original app's design and characteristic. The adaptation layer 235 binds the protocol with particular implementations of different apps using dependence registration during service layer initialization. The service layer indirectly uses the app's particular implementation by invoking an interface defined by the adaptation layer.

The application environment 240 includes one or more apps, and the apps can be located at the same or different mobile terminals with different apps having different network ports/addresses and user behavior detections, or the like.

The server 245 is used to provide data for the client. The adaptation layer 260 of the server enables data to be acquired from the server using a uniform interface for various apps. The adaptation layer 280 of the server can respond to an individual app's request and returns data corresponding to the individual app. Data of the server may be classified into static data 250 and dynamic data 255. Dynamic data may include market data 280, app data 265, discount data 207, and inventory data 275, for example.

When a component is a User Interface (UI) component, the component can be stored in the component library 215 of the client.

For example, if a key value of a common component is set to A, then a corresponding component implementation class may be set for A. If a component implementation class is represented by B, then specific contents of the key value A and specific contents of the component implementation class B can be stored in the component library, and an association between the key value A and the component implementation class B is established. Specifically, the association between the key value A and the component implementation class B can be recorded in a component mapping configuration table in the component library.

Unlike development of individual apps using distinct components, the common component A can be used by different apps, and repetitive development and the wasting of resources can be avoided.

An acquisition module 42 acquires characteristic data from a server according to information related to the application and information of the function item when a function item of the application is to be activated. The characteristic data may include static data and/or dynamic data, and different apps may have different characteristic data.

The characteristic data depends on the function items to be started. For example, when the page content is to be displayed, the characteristic data may include interface data associated with the page content to be displayed and a layout template data for the page. In the case that the page contents to be displayed are commodity details, the interface data, for example, may include information related to commodity details such as commodity images, commodity titles, commodity prices, commodity locations, and the like. The layout template data is used for defining the layout of the displayed page, for example, which components need to be used and the presentation sequence of the necessary components.

According to some embodiments, the acquisition module 42 is used for acquiring characteristic data from the server based on information related to the application and information related to the function item. The acquisition module is capable of sending a request message to the adaptation layer of the server, where the request message contains information related to the application and information of the function item, and receiving characteristic data sent by the server, where the characteristic data was acquired by the server according to information related to the application and information of the function item. The adaptation layer of the server is able to receive request messages sent by different applications.

For example, referring to FIG. 2, the server is provided with the adaptation layer, where different apps may send request messages to the unified adaptation layer of the server using the data layer of the client. Associations between information related to the applications, information related to the function items, and characteristic data may be pre-configured at the client to acquire corresponding characteristic data using information related to the applications and information related the function items. Information related to the application, for example, may include names and version number of applications, and when the commodity detail pages are displayed, information related to the function item may include, for example, an ID of the commodity to be displayed.

A determination module 43 is used for determining necessary components in the component library based on the characteristic data. For example, the characteristic data may include information related to the necessary components used to determine which components are necessary.

A starting module 44 is used for starting, initializing, and/or executing the function item based on the necessary components.

After determining the necessary components, specific component implementation classes stored in the component library can be used to implement and/or enable functions of the components, and when a plurality of components need to be used, functions of a plurality of necessary components may be combined to start the function items of the application.

By storing the components in the component library, where the components may be used by different applications, the necessary component may be created/established once, instead of establishing separate components for each application. Therefore, the efficiency of the application may be improved and the wasting of resources may be reduced.

According to some embodiments, when the function item displays page content, the characteristic data may include interface data associated with the page content to be displayed, and layout template data of the displayed page, where the layout template data contains information related to the necessary components for determining which components are necessary.

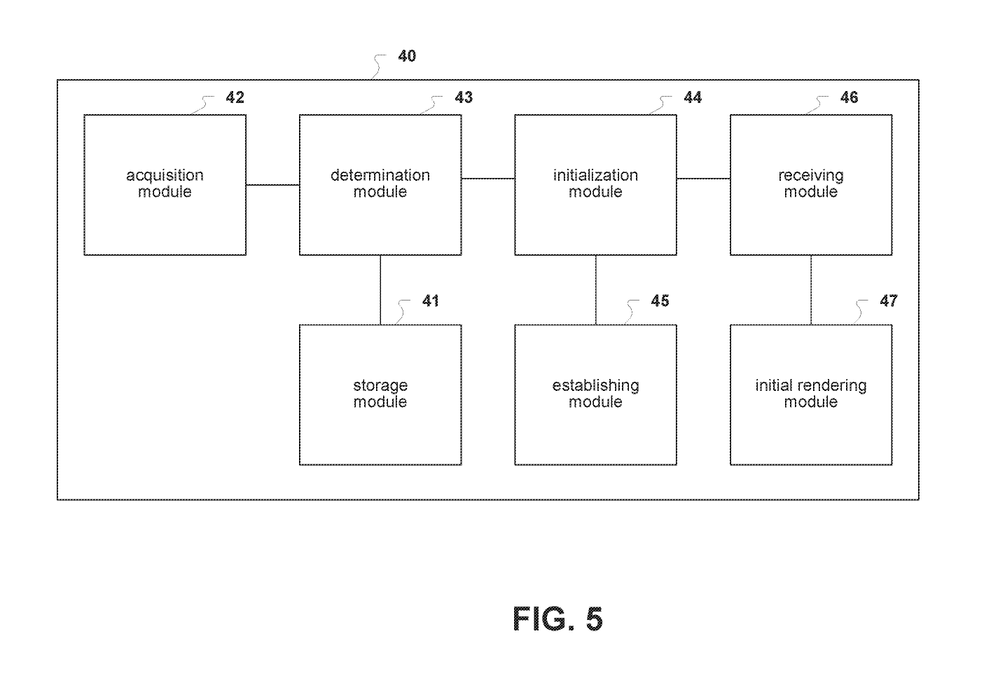

Referring to FIG. 5, the device 40 includes an establishing module 45 for establishing an association between the component and a view model, and the initialization module 44 is specifically used for determining an initial view model corresponding to the necessary components based on the necessary components and the association between the components and the view model. The initialization module 44 is further used for updating the initial view model according to the layout template data and the interface data to acquire an updated view model, perform a page rendering process using the updated view model, and display the rendered page.

According to some embodiments, the establishing module 45 is specifically used for establishing an association between the component and the view model in a data layer, and the view model is used for graphical rendering and contains information used by the graphical rendering component of the UI.

Specifically, the association between the component and the view model can be established using a data layer. For example, a key value A may correspond to a view model C.

Still referring to FIG. 5, the device 40 includes a receiving module 46 for receiving a request message sent by a page loader of the application, the request message containing information related to the application and information related to the function item used to determine the function item of the application to be started, and acquiring information related to the application and information related to the function item.

Information related to the application, for example, may include names and version numbers of the applications.

Information related to the function item may include an ID of the commodity of the detail page to be displayed.

When the request message sent by the page loader is received by the data layer, the commodity detail page of the application to be started can be determined, and the request message is sent to the adaptation layer of the server to acquire the characteristic data.

According to some embodiments, referring to FIG. 5, the device 40 further includes an initial rendering module 47 for performing an initial rendering of the page according to the initial layout template data and basic information, and presenting the page after the initial rendering.

The initial layout template data and basic information can be pre-configured, so that the user can see the basic page content such as titles and prices of the displayed commodity, or the like.

According to some embodiments, the component is a UI component, the component library and the data layer are located at a client, and the client further comprises a service packet corresponding to the application within which the page loader is located.

According to some embodiments, the client further comprises other modules commonly available to different applications, where the other modules comprise one or more of the following items: a core library, a flow management module, and a life cycle management module.

According to some embodiments, the client further comprises an adaptation layer, the adaptation layer including implementation information of different applications, and during rendering, the data layer performs a rendering process according to the implementation information of the corresponding applications.

According to some embodiments, various apps can be divided into common components, and with a single development process, the services can be quickly applied to different apps of a mobile terminal. In this way, the research and/or development costs are greatly reduced, and the services can be brought on-line quickly and in parallel.

It should be noted that, in the descriptions of the present application, terms such as “a first” and “a second” or the like are only used for the purpose of description, and are not construed as indication or implication of relative importance. Additionally, in the descriptions of the present application, unless otherwise indicated, term “a plurality of” means at least two.

Any process or method descriptions in flow charts or otherwise described herein should be understood as representing modules, segments or portions of codes which include one or more executable instructions for implementing specific logical functions or steps in the process, and alternative implementations are included within the scope of the preferred embodiment of the present application in which functions may be executed in an order different from that shown or discussed, including substantially concurrently or in reverse order, depending on the functionality involved, as would be understood by those skilled in the art of the embodiments of the present application.

It should be understood that individual portions of the present application can be implemented through hardware, software, firmware or a combination thereof. In the above embodiments, a plurality of steps or methods can be implemented by software or firmware stored in a memory and executed by a suitable instruction execution system. For example, if it is implemented in hardware, as in the other embodiment, it can be implemented with any one or a combination of the following technologies which are well known in the art: a discrete logic circuit having logic gates for implementing logic functions on data signals, an application specific integrated circuit having appropriate combinational logic gates, a programmable gate array (PGA), a field programmable gate array (FPGA), and the like.

Those of ordinary skills in the art can appreciate that all or some of the steps involved in the above embodiment method may be realized by a program instructing relevant hardware, where said program may be stored in a computer readable storage medium and comprises, when executed, one or a combination of the steps of the method embodiment. Furthermore, individual functional units in each embodiment of the present application may be integrated in a processing module, or individual units may also physically exist separately, or two or more units may also be integrated in a module. The above integrated modules may be implemented in the form of hardware or in the form of software function module. The integrated modules, when being implemented in the form of software function modules and being sold or used as independent products, can be stored in a computer-readable storage medium.

The above-mentioned storage medium can be a read-only memory, a diskette or an optical disk, or the like.

In the description of the specification, descriptions of reference terms “an embodiment”, “some embodiments”, “example”, “a specific example” or “some examples” or the like mean that specific features, structures, materials or characteristics described in combination with the embodiment or example are included in at least one embodiment or example of the present application. In the specification, schematic expressions of the above terms do not necessarily refer to the same embodiment or example. Moreover, the described specific features, structures, materials or characteristics can be combined in appropriate ways in any one or more embodiments or examples.

Although embodiments of the present application have been illustrated and described herein, it will be appreciated that the above embodiments are illustrative and cannot be construed as limiting the present application, those of ordinary skills in the art can make changes, modifications, substitutions and variations to the above embodiments within the scope of the present application.

1. A method for implementing a function item of an application using pre-generated components, the method comprising:
storing the pre-generated components in a component library;
acquiring characteristic data from a server based on information related to the application and information related to the function item of the application, responsive to a request to start the function item of the application;
determining a necessary component in the component library for starting the function item based on the characteristic data; and
starting the function item using the necessary component.

2. The method of claim 1, wherein when the function item is used to display content of a page, and the characteristic data comprises interface data associated with the content, and layout template data of the page, wherein the layout template data comprises information related to the necessary component for determining the necessary component, wherein the method further comprises establishing an association between the necessary component and a view model, and wherein the starting of the function item using the necessary component comprises:
determining an initial view model corresponding to the necessary components based on the necessary component and the association between the necessary component and the view model;
updating the initial view model using the layout template data and the interface data to acquire an updated view model;
performing a page rendering process using the updated view model to generate a rendered page; and
displaying the rendered page.

3. The method of claim 2, further comprising:
receiving a request message sent by a page loader of the application, wherein the request message comprises information related to the application and information related to the function item, and wherein the information related to the application and the information related to the function item is used to determine the function item of the application to be started; and
acquiring information related to the application and information related to the function item, wherein the establishing an association between the necessary component and the view model comprises establishing an association between the necessary component and the view model using a data layer.

4. The method of claim 3, further comprising:
performing an initial rendering process of the page according to the initial layout template data and basic information to generate an initial rendering; and
displaying the page using the initial rendering.

5. The method of claim 3, wherein the necessary component comprises a UI component, the component library and the data layer are located at a client device, and the client device comprises a service packet corresponding to the application.

6. The method of claim 5, wherein the client further comprises other modules, wherein the other modules are available to different applications, and the other modules comprise one or more of: a core library, a flow management module, and a life cycle management module.

7. The method of claim 5, wherein the client further comprises an adaptation layer, the adaptation layer comprises implementation information for different applications, and the data layer performs a rendering process according to the implementation information.

8. The method of claim 1, wherein the acquiring characteristic data from the server based on information related to the application and information related to the function item comprises:
sending a request message to the adaptation layer of the server, the request message comprising the information related to the application and the information related to the function item; and
receiving characteristic data sent by the server, wherein the characteristic data is acquired by the server based on the information related to the application and the information related to the function item,
wherein the adaptation layer of the server is capable of receiving request messages sent by different applications.

9. A device for executing an application using common components, comprising:
a memory for storing pre-generated components in a component library;
a processor communicatively couple to the memory that acquires characteristic data from a server based on information related to the application and information related to the function item responsive to a request to execute a function item of the application, determines a necessary component for the function item in the component library based on the characteristic data, and starts the function item using the necessary component.

10. The device of claim 9, wherein the processor:
determines an initial view model corresponding to the necessary components based on the necessary component and the association between the necessary component and the view model;
updates the initial view model according to layout template data and interface data to generate an updated view model
performs a page rendering process using the updated view model to generate a rendered page; and
displays the rendered page,
wherein when the function item comprises page content, and the characteristic data comprises the interface data associated with the page content and the layout template data of the displayed page, wherein the layout template data comprises data for determining the necessary component.

11. A computer usable medium having computer-readable program code embodied therein for causing a computer system to execute a method of processing an application, the method comprising:
storing pre-generated components in a component library;
acquiring characteristic data from a server based on information related to an application and information related to a function item of the application, responsive to a request to start the function item of the application;
determining a necessary component in the component library for starting the function item based on the characteristic data; and
starting the function item using the necessary component.

12. The method of claim 11, wherein when the function item is used to display content of a page, the characteristic data comprises interface data associated with the content and layout template data of the page, and wherein the layout template data comprises information related to the necessary component used to determine the necessary component, and the method further comprises:
establishing an association between the necessary component and a view model; and
the starting the function item using the necessary component comprises:
determining an initial view model corresponding to the necessary components based on the necessary component and the association between the necessary component and the view model;
updating the initial view model according to the layout template data and the interface data to acquire an updated view model;
performing a page rendering process using the updated view model to generate a rendered page; and
displaying the rendered page.

13. The method of claim 12, further comprising receiving a request message sent by a page loader of the application, wherein the request message comprises information related to the application and information related to the function item used to determine the function item of the application to be started.

14. The method of claim 13, wherein the necessary component comprises a UI component, the component library and the data layer are located at a client device, and the client device comprises a service packet corresponding to the application.

15. The method of claim 14, wherein the client further comprises other modules, wherein the other modules are available to different applications, and the other modules comprise one or more of: a core library, a flow management module, and a life cycle management module.

16. The method according to claim 14, wherein the client further comprises an adaptation layer, wherein the adaptation layer includes implementation information for different applications, and the data layer performs a rendering process using the implementation information.

17. The method of claim 11, wherein the acquiring characteristic data from the server based on information related to the application and information related to the function item comprises:
sending a request message to the adaptation layer of the server, the request message comprising information related to the application and information related to the function item; and
receiving characteristic data sent by the server, wherein the characteristic data is acquired by the server based on the information related to the application and the information related to the function item.

18. The method of claim 17, wherein the adaptation layer of the server is capable of receiving request messages sent by different applications.

19. The method of claim 18, wherein the adaptation layer of the server is capable of receiving request messages sent by different applications in parallel, and the server is capable of responding to the request messages in parallel.

20. The method of claim 13, further comprising acquiring information related to the application and information related to the function item, wherein the establishing an association between the component and the view model comprises establishing an association between the component and the view model using a data layer.
